(19) United States
(12) Patent Application Publication
(10) Pub. No.: US 2004/0035958 A1
(43) Pub. Date: Feb. 26, 2004

(54) Two-piece nozzle assembly for use with high pressure fluid cutting systems and bushing for use therewith

(76) Inventor: Terry Dean Gromes SR., Navarre, OH (US)

Correspondence Address: Joseph A. Sebolt, SAND & SEBOLT, Aegis Tower, Suite 1100, 4940 Munson Street, N.W., Canton, OH, 44718, US

(21) Appl. No.: 10/225,392

(22) Filed: Aug. 20, 2002

(51) Int. Cl. B05B 1/00

(52) U.S. Cl. 239/596

(57) ABSTRACT

A high velocity cutting nozzle for connection to the fluid supply tube of a high pressure fluid cutting system. The nozzle includes a housing which threadably connects to the fluid supply tube for receiving pressurized liquid therefrom. A bushing disposed within the housing sandwiches a removable sleeved jeweled orifice disk therebetween at a spray outlet bore of the housing. The bushing includes a flow directing bore with a convergent inlet portion for reducing turbulence, and an outlet portion having an annular cylindrical or divergent inner surface, and an annular convergent angled or curved end surface. The sleeved orifice disk is in co-axial fluid communication with the flow-directing bore and a spray outlet bore of the housing to facilitate fluid flow. The sleeved orifice disk fits within a sleeve receiving bore in the bushing immediately downstream of the flow-directing bore abutting a shoulder of the bushing.

### BACKGROUND OF THE INVENTION

1. Technical Field

Generally, the invention relates to high pressure fluid cutting systems. Particularly, the invention relates to high velocity cutting nozzles for connection to the fluid supply tube of high pressure fluid cutting systems. Specifically, the invention relates to cutting nozzles comprising a housing which threadably connects to the fluid supply tube for receiving pressurized liquid therefrom, with a bushing disposed in the housing that sandwiches a removable sleeved orifice disk therebetween at a spray outlet bore of the housing.

2. Background Information

High pressure liquid cutting devices are commonly used for cutting various sheet materials such as plastics, and masonry materials such as brick and concrete slabs. Such cutting devices are also used for drilling and abrading materials. Such devices are also often used to clean materials such as masonary and steel. Such cutting devices usually include an electric motor which drives a hydraulic pump supplying a working fluid to a high pressure intensifier unit. The intensifier draws a cutting liquid in the form of water from a reservoir, and discharges the water at a very high pressure (e.g. 20,000 to 70,000 psi or more) through the fluid supply tube to the cutting nozzle to produce a fluid jet to cut through the desired material. The fluid jet may range in diameter from about a thousandth of an inch up to about fifteen thousandths of an inch or more, at a velocity of about 1,000 to 3,000 feet per second.

Many prior art cutting nozzles are prone to prematurely wearing out due to abrasion caused by the high pressure and velocity of the water traveling through the nozzles upstream of the orifice. Turbulence upstream of the orifice also causes lack of cohesiveness of the fluid jet. That is, convergence of the various velocity vectors of the fluid within the fluid jet at the orifice only extends for a short distance upon exiting the orifice. This results in a more dispersed fluid jet having less cutting force so only shallower cuts may be made, a wider width of cut or kerf, and more overspraying or wetting of the material adjacent the cut. Conversely, a more cohesive fluid jet provides a finer fluid jet, more precise cutting, and deeper cuts.

One attempt to reduce such turbulence is a liquid jet cutting device and method disclosed in U.S. Pat. No. 3,997,111 issued to Thomas et al. on Dec. 14, 1976. The disclosed device includes a source of high pressure fluid, a jet nozzle, and a high pressure conduit connecting the fluid source to the nozzle. A liquid collimating device is disposed directly upstream of the nozzle comprising a housing interconnected between the conduit and the nozzle. The housing defines a flow collimating chamber directly upstream of the nozzle through which the high pressure liquid is delivered to the nozzle. The cross-sectional area of the flow collimating chamber must be at least greater than one hundred times the cross-sectional area of the nozzle opening. The liquid jet produced is claimed to have relatively little dispersion and a relatively narrow kerf.

An orifice assembly and method providing highly cohesive fluid jet is disclosed in U.S. Pat. No. 5,226,597 issued to Ursic on Jul. 13, 1993. The orifice assembly includes a housing that receives pressurized fluid from a supply tube. The housing has a passageway therein through which the fluid flows. The passageway has an orifice element therein having an orifice for producing the fluid jet, and a converging section disposed upstream of the orifice that extends toward the orifice element. The converging section is designed to reduce turbulence upstream of the orifice and thus produce a more cohesive fluid jet emitted from the orifice. A section having a rounded surface is disposed between the converging section and the orifice element which joins the converging section and an upstream portion of the orifice element. The section is designed to further improve the cohesiveness of the fluid jet by further reducing turbulence upstream of the orifice.

Although these devices are adequate for the purpose for which they were intended, the first device has additional length and adds weight to the cutting assembly. Additionally, neither device directly addresses the problem of nozzle wear.

Another problem with prior art nozzles is the inability to easily change orifice sizes when the particular material requires such. The sapphire orifice disk is typically affixed to the nozzle housing requiring changing out of the entire nozzle, or the use of a press to remove the orifice disk from the housing. Furthermore, the same must be done to replace a worn out orifice disk. If the orifice disk cannot be removed, the entire nozzle must be scrapped.

Therefore, the need exists for an improved high velocity cutting nozzle that reduces turbulence upstream of the orifice to produce a narrow kerf, that has a significantly longer service life prior to wearing out, and having easily replaceable orifice disks.

### SUMMARY OF THE INVENTION

Objectives of the invention include providing a high pressure cutting nozzle which has reduced turbulence.

Another objective is to provide a high pressure cutting nozzle with significantly reduced internal wear due to abrasion of the water flow providing a longer service life.

A further objective is to provide a high pressure cutting nozzle in which orifice disks are easily changed to ones having a different orifice size or replaced when worn out.

A still further objective of the invention is to provide such a high pressure cutting nozzle which includes a separate housing and bushing between which the orifice disk is sandwiched, and which solves problems and satisfies needs existing in the art.

These objectives and advantages are obtained by the improved high velocity cutting nozzle for connection to a fluid supply tube of a high pressure fluid cutting system of the present invention, the general nature of which may be stated as including: a housing adapted for connection to the fluid supply tube, a bushing receiving bore extending from the fluid supply tube partially through the housing, and a spray outlet bore extending inwardly from a front surface of the housing which joins with the bushing receiving bore through which the liquid is directed as a high velocity liquid cutting jet; a bushing that closely fits within the bushing receiving bore, having an end surface adapted to closely sealingly engage a mating surface of the housing within the bushing receiving bore, the bushing having a flow-directing bore for receiving the liquid from the fluid supply tube and extending at least partially through the bushing, the flow directing bore including a convergent inlet portion having an annular inner surface for reducing turbulence in the flow-directing bore, and an outlet portion having an annular inner surface and a convergent end surface; and an orifice plate in co-axial fluid communication with the flow-directing bore and the spray outlet bore, the orifice plate fitting within a sleeve receiving bore in one of the bushing and the housing immediately downstream of the flow-directing bore and abutting a shoulder of the bushing, the orifice plate having an orifice of a diameter that is smaller than a minimum diameter of the flow-directing bore for producing a high velocity fluid jet, with the orifice plate being sandwiched between the bushing and the housing.

According to another aspect, the objectives and advantages are obtained by the improved method for extending the service life of a high velocity cutting nozzle, the general nature of which may be stated as including the steps of: producing a flow of high pressure fluid; passing the flow through a flow-directing bore including a convergent inlet portion having an annular inner surface, and through an outlet portion having an annular inner surface and a convergent end surface to remove turbulence; and passing the flow through an orifice closely adjacent the flow-directing bore having an orifice of a diameter that is smaller than a minimum diameter of the flow-directing bore for producing a high velocity fluid jet.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is a schematic view of a high pressure water cutting system of the type that may utilize the cutting nozzles of the present invention;

FIG. 2 is a fragmentary longitudinal sectional view of a first embodiment of the cutting nozzle of the present invention having a flow directing bore that includes a straight outlet portion having an annular straight surface and an annular curved convergent surface;

FIG. 3 is a fragmentary longitudinal sectional view of a second embodiment of the cutting nozzle of the present invention having a flow directing bore that includes a straight outlet portion having an annular straight surface and an annular angled convergent surface;

FIG. 4 is a fragmentary longitudinal sectional view of a third embodiment of the cutting nozzle of the present invention having a flow directing bore that includes a flared outlet portion having an annular flared surface and an annular curved convergent surface;

FIG. 5 is a fragmentary longitudinal sectional view of a fourth embodiment of the cutting nozzle of the present invention having a flow directing bore that includes a flared outlet portion having an annular flared surface and an annular curved convergent surface;

FIG. 6 is a partially exploded perspective view of the housing and bushing, with the sleeve, and orifice disk installed within the bushing of the cutting nozzles;

FIG. 7 is an exploded perspective view of the housing, bushing, sleeve, and orifice disk of the cutting nozzle;

FIG. 8 is an exploded perspective view of the housing, bushing, sleeve, orifice disk, and an alternate orifice disk having a larger orifice of the cutting nozzle; and

FIG. 9 is a partially exploded perspective view of the housing, bushing, and orifice disk, with the sleeve, and alternate orifice disk installed within the bushing of the cutting nozzle.

Similar numerals refer to similar parts throughout the drawings.

### DESCRIPTION OF THE PREFERRED EMBODIMENT

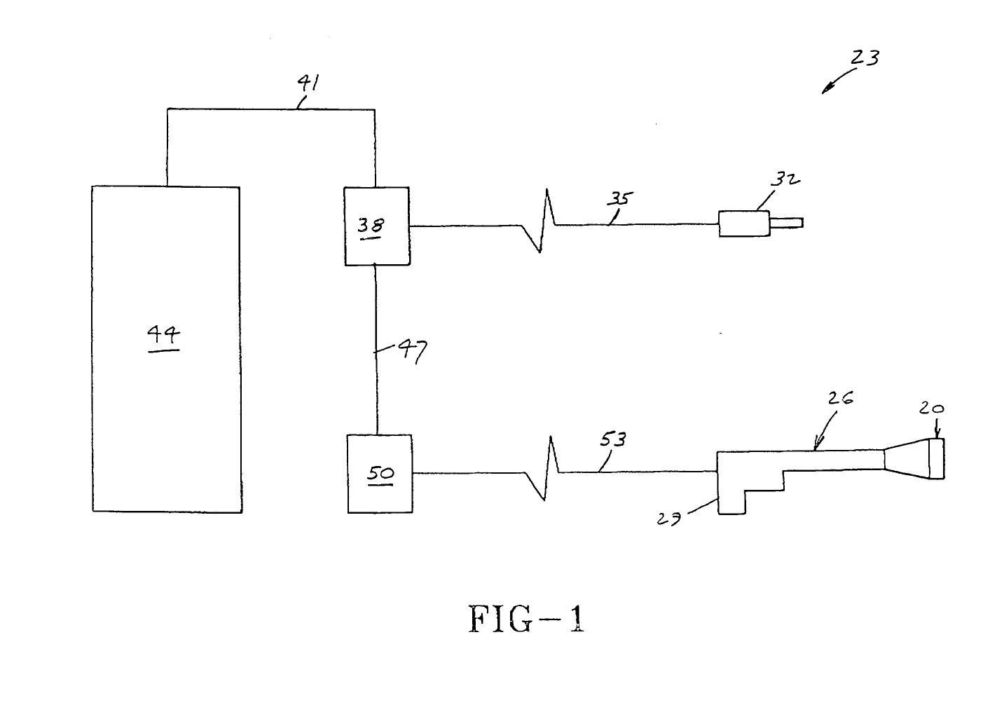

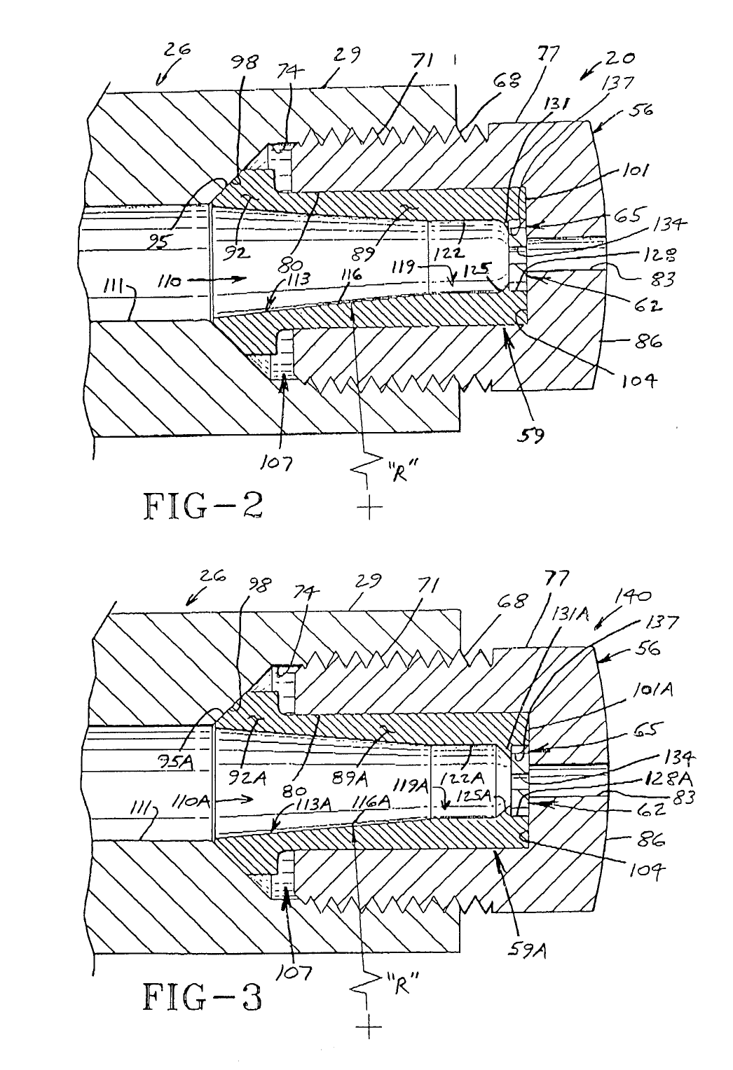

The high velocity cutting nozzle of the present invention is shown in FIGS. 1 and 2, and is indicated generally at 20. Cutting nozzle 20 is shown in FIG. 1 positioned as part of a high pressure water cutting system 23. Cutting system 23 includes a cutting gun 26 having a fluid supply tube 29 to which the cutting nozzle 20 is engaged as explained subsequently. Gun 26 receives high pressure water produced by an electric powered hydraulic pump 32 that supplies a working fluid such as hydraulic fluid through a pipe 35 to a high pressure intensifier unit 38. The intensifier unit 38 draws a suitable cutting fluid (i.e. water) through a pipe 41 from a reservoir 44, and discharges the water at a very high pressure through a pipe 47 to an ultra-fine filter 50 to remove any small particulates that might plug up the cutting nozzle 20. The water passes from filter 50 through a pipe 53 to the fluid supply tube 29 of gun 26.

Cutting nozzle 20 includes a housing 56 preferably made of high strength steel, a bushing 59 preferably made of steel, an orifice disk 62 preferably made of sapphire, and a sleeve 65 preferably made of plastic or rubber. The housing 56 is generally cylindrical in shape, having an externally threaded portion 68 configured to engage an internally threaded portion 71 of a bore 74 of fluid supply tube 26 of standard guns 26, and a wrench engaging external hexagonal portion 77 adapted to be engaged by standard hex wrenches (not shown). A bushing receiving bore 80 extends through the threaded portion 68 and partially into the hexagonal portion 77. A spray outlet bore 83 extends from a convex front surface 86 of housing 56 into the hexagonal portion 77 and joins with the bushing receiving bore 80. The bushing 59 includes a cylindrical body 89 terminating at a head 92, the body 89 being of a diameter to closely fit within the bushing receiving bore 80, with head 92 being of a larger diameter. Head 92 includes a frustoconical or annular tapered surface 95 adapted to engage a mating frustoconical or annular tapered surface 98 of fluid supply tube 29 when cutting nozzle 20 is assembled to gun 26. A flat end surface 101 of bushing 59 closely engages a mating circular surface 104 of housing 56 within bushing receiving bore 80 when bushing 59 is assembled within housing 56, with an annular space 107 remaining between head 92 and threaded portion 68. The bushing 59 further includes a flow directing bore 110 coaxially disposed with a water outlet bore 111 of fluid supply tube 29 of gun 26, the flow directing bore 110 having a longitudinally tapered inlet portion 113 having an angular funnel-shaped surface 116 and a straight outlet portion 119 having a cylindrical straight surface 122 and a cylindrical curved convergent surface 125. Surface 116 could also be slightly convex without departing from the spirit of the present invention. A sleeve receiving bore 128 extends inwardly from flat surface 101 of bushing 59 joining with the outlet portion 119 of flow directing bore 110 at a shoulder 131. The orifice disk 62 includes an orifice 134 of a desired cutting diameter, and pressfits into an inner bore 137 of sleeve 65. Sleeve 65 closely, but removably fits into the sleeve receiving bore 128 of bushing 59.

A second embodiment of the cutting nozzle of the present invention is indicated at 140 in FIG. 3. Cutting nozzle 140 includes the housing 56, a bushing 59A, the orifice disk 62, and the sleeve 65. The bushing 59A includes a cylindrical body 89A terminating at a head 92A, the body 89A being of a diameter to closely fit within the bushing receiving bore 80, with head 92A being of a larger diameter. Head 92A includes an annular tapered surface 95A adapted to engage the annular or cylindrical tapered surface 98 of fluid supply tube 29 when cutting nozzle 140 is assembled to gun 26. A flat end surface 101A of bushing 59A closely engages the circular surface 104 of housing 56 within bushing receiving bore 80 when bushing 59A is assembled within housing 56, with the annular space 107 remaining between head 92A and threaded portion 68. The bushing 59A further includes a flow directing bore 10A coaxially disposed with the water outlet bore 111 of fluid supply tube 29 of gun 26, the flow directing bore 110A having the longitudinally tapered inlet portion 113A having the funnel-shaped surface 116A and a straight outlet portion 119A having a cylindrical straight surface 122A and an annular angled convergent surface 125A. A sleeve receiving bore 128A extends inwardly from flat surface 101A of bushing 59A joining with the outlet portion 119A of flow directing bore 110A at a shoulder 131A. The orifice disk 62 includes the orifice 134 of a desired cutting diameter, and pressfits into the inner bore 137 of sleeve 65. Sleeve 65 closely, but removably fits into the sleeve receiving bore 128A of bushing 59A.

A third embodiment of the cutting nozzle of the present invention is indicated at 143 in FIG. 4. Cutting nozzle 140 includes the housing 56, a bushing 59B, the orifice disk 62, and the sleeve 65. The bushing 59B includes a cylindrical body 89B terminating at a head 92B, the body 89B being of a diameter to closely fit within the bushing receiving bore 80, with head 92B being of a larger diameter. Head 92B includes tapered surface 95B adapted to engage the tapered surface 98 of fluid supply tube 29 when cutting nozzle 140 is assembled to gun 26. A flat end surface 101B of bushing 59B closely engages the circular surface 104 of housing 56 within bushing receiving bore 80 when bushing 59B is assembled within housing 56, with the annular space 107 remaining between head 92B and threaded portion 68. The bushing 59B further includes a flow directing bore 110B coaxially disposed with the water outlet bore 111 of fluid supply tube 29 of gun 26, the flow directing bore 110B having the longitudinally tapered inlet portion 113B having a funnel-shaped surface 116B and a flared divergent outlet portion 119B having an annular flared surface 122B and an annular curved convergent surface 125B. A sleeve receiving bore 128B extends inwardly from flat surface 101B of bushing 59B joining with the outlet portion 119B of flow directing bore 110B at a shoulder 131B. The orifice disk 62 includes the orifice 134 of a desired cutting diameter, and pressfits into the inner bore 137 of sleeve 65. Sleeve 65 closely, but removably fits into the sleeve receiving bore 128B of bushing 59B.

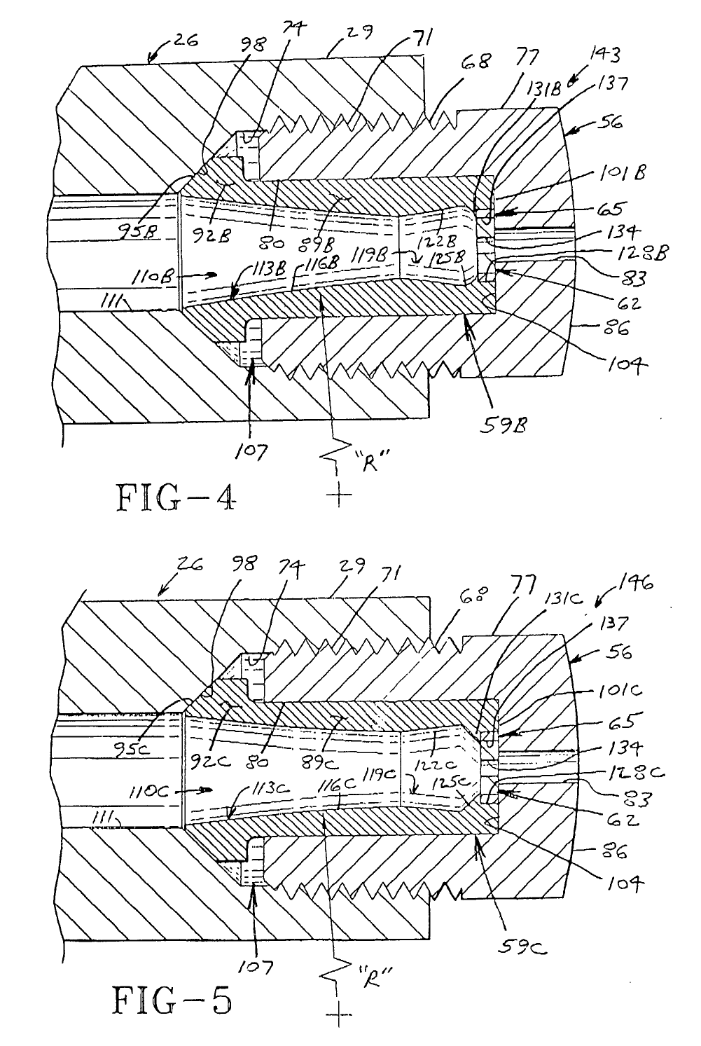

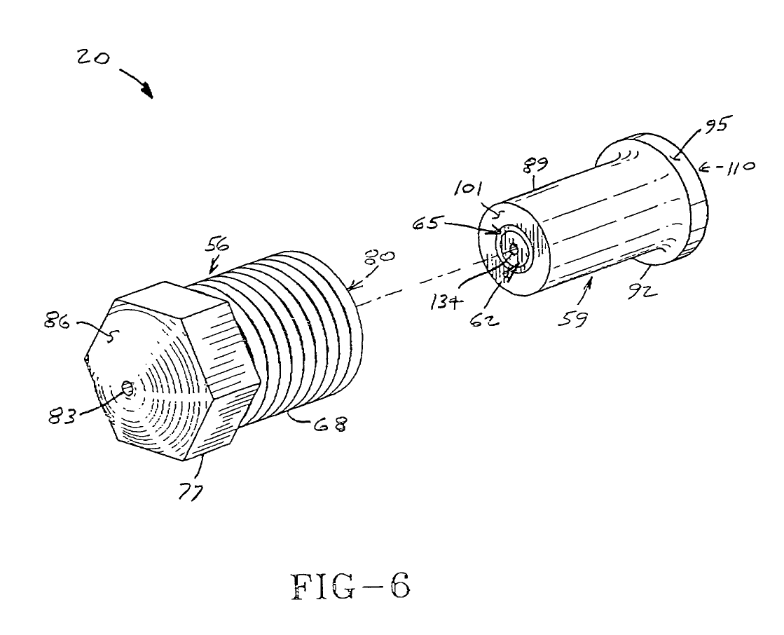

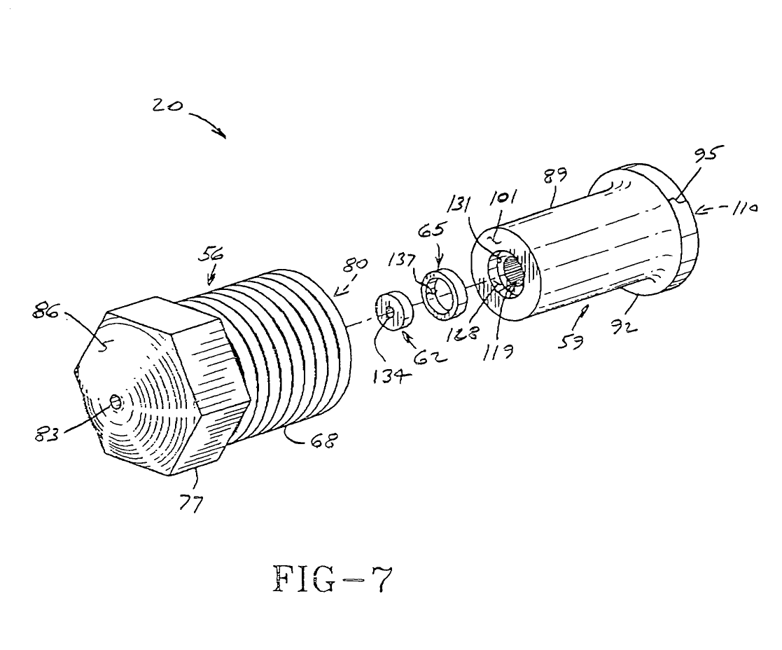

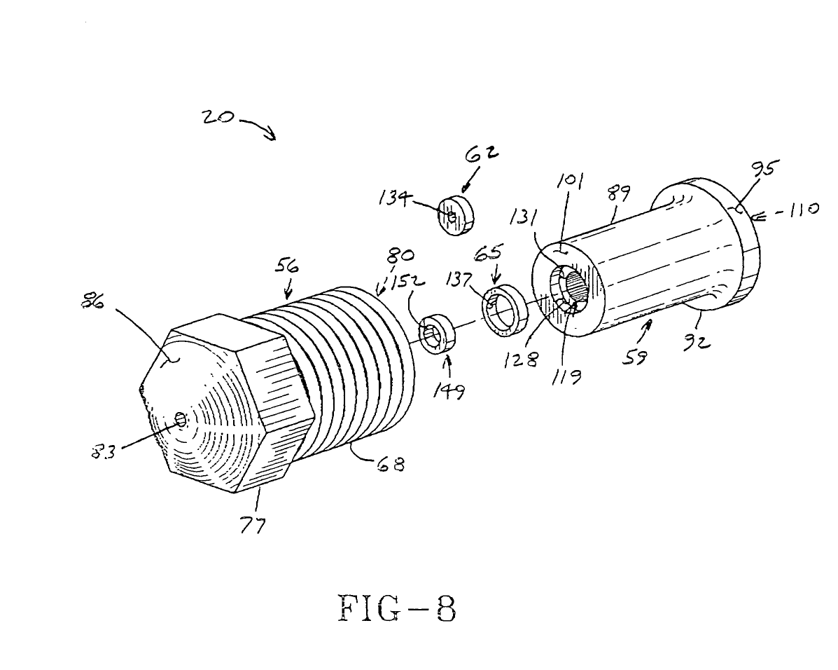

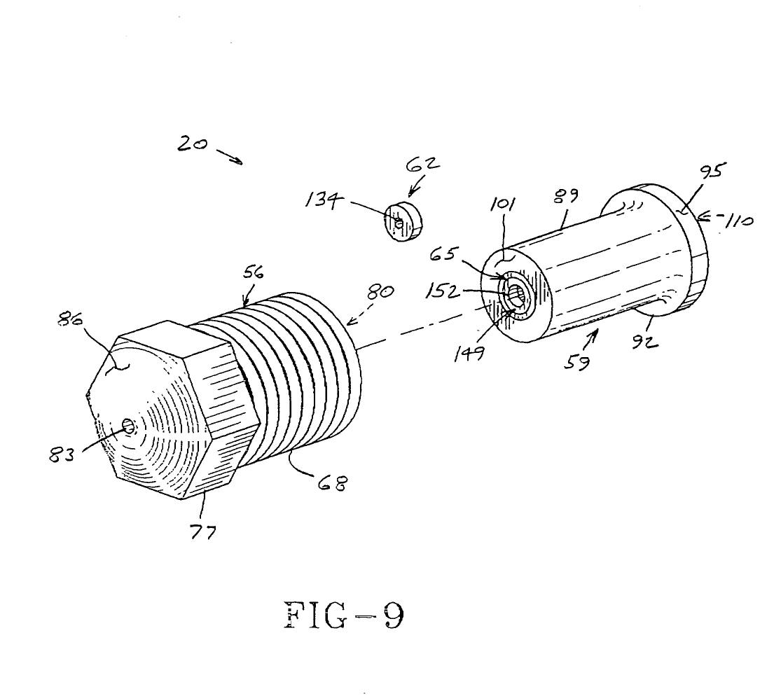

A fourth embodiment of the cutting nozzle of the present invention is indicated at 146 in FIG. 5. Cutting nozzle 140 includes the housing 56, a bushing 59C, the orifice disk 62, and the sleeve 65. The bushing 59C includes a cylindrical body 89C terminating at a head 92C, the body 89C being of a diameter to closely fit within the bushing receiving bore 80, with head 92C being of a larger diameter. Head 92C includes an annular tapered surface 95C adapted to engage the annular tapered surface 98 of fluid supply tube 29 when cutting nozzle 140 is assembled to gun 26. A flat end surface 101C of bushing 59C closely engages the circular surface 104 of housing 56 within bushing receiving bore 80 when bushing 59C is assembled within housing 56, with the annular space 107 remaining between head 92C and threaded portion 68. The bushing 59C further includes a flow directing bore 110C coaxially disposed with the water outlet bore 111 of fluid supply tube 29 of gun 26, the flow directing bore 110C having the longitudinally tapered inlet portion 113C having a funnel-shaped surface 116C and a flared divergent outlet portion 119C having an annular flared surface 122C and an annular curved convergent surface 125C. A sleeve receiving bore 128C extends inwardly from flat surface 101C of bushing 59C joining with the outlet portion 119C of flow directing bore 110C at a shoulder 131C. The orifice disk 62 includes the orifice 134 of a desired cutting diameter, and pressfits into the inner bore 137 of sleeve 65. Sleeve 65 closely, but removably fits into the sleeve receiving bore 128C of bushing 59C.

The cutting nozzle 20 (as well as cutting nozzles 140, 143, and 146) threadably connects to the fluid supply tube 29 of gun 26 by engaging a wrench to the external hexagonal portion 77 of housing 56. The annular tapered surface 95 of bushing 59 engages the annular tapered surface 98 of fluid supply tube 29 as cutting nozzle 20 is tightened, forcing bushing 59 further into the bushing receiving bore 80. The flat end surface 101 of bushing 59 closely engages the mating circular surface 104 of housing 56 within bushing receiving bore 80, sealing nozzle 20 to fluid supply tube 29. The orifice disk 62 and sleeve 65 are retained within the sleeve receiving bore 128 by the shoulder 131 without being pressfit or otherwise affixed therein. Therefore, upon disassembly of cutting nozzle 20, the orifice disk 62 with sleeve 65 readily slides out of the sleeve receiving bore 128 without using tools, and may be replaced by an orifice disk 149 within another sleeve 65 having a different size orifice 152 to suite a different cutting job. Likewise, when orifice disk 62 wears out, it may readily be replaced without throwing out the entire cutting nozzle 20. The cutting nozzle 20 fastens directly to conventional fluid supply tubes 29 and requires no modification thereto.

The method of operation includes the following steps: 1) producing a flow of high pressure fluid; 2) passing the flow through a flow-directing bore including a convergent inlet portion having an annular inner surface, and through an outlet portion having an annular inner surface and a convergent end surface to remove turbulence; and 3) passing the flow through an orifice closely adjacent the flow-directing bore having an orifice of a diameter that is smaller than a minimum diameter of the flow-directing bore for producing a high velocity fluid jet. The outlet portion has one of four configurations: a) the annular inner surface is a cylindrical surface with an annular curved convergent surface downstream thereof; b) the annular inner surface is a cylindrical surface with an annular straight convergent surface downstream thereof; c) the annular inner surface is an annular straight divergent surface with an annular curved convergent surface downstream thereof; and d) the annular inner surface is an annular straight divergent surface and an annular straight convergent surface downstream thereof. In operation, it is believed that the inwardly convex convergent inlet portion of the flow directing bore stabilizes the flow of water to reduces turbulence in the flow-directing bore, producing a more laminar and coherent flow prior to entering the orifice. The various configurations of the outlet portion augment this process by smoothly directing the flow into the orifice, with or without a slight initial expansion of the flow area prior to entering the orifice. The result is less turbulence in the flow producing less wear and a tighter kerf.

It is understood that various materials other than those listed may be used in the construction of the cutting nozzles and various finishes be applied. For example, the bushing might be made of brass or a sand blast finish applied to all the water contacting surfaces rather than a smooth finish to improve cohesiveness of the flow. Also, other housing and bushing configurations may be devised. For example, the sleeve receiving bore may be disposed in the housing rather than in the bushing.

Accordingly, the cutting nozzles provide reduced turbulence to produce a finer kerf, significantly reduced internal wear due to abrasion of the water flow providing a longer service life, orifice disks that are easily changed to ones having a different orifice size or replaced when worn out, and a separate housing and bushing between which the orifice disk is sandwiched which achieves all the enumerated objectives, provides for eliminating difficulties encountered with prior art devices, and solves problems and obtains new results in the art.

In the foregoing description, certain terms have been used for brevity, clearness and understanding; but no unnecessary limitations are to be implied therefrom beyond the requirements of the prior art, because such terms are used for descriptive purposes and are intended to be broadly construed.

Moreover, the description and illustration of the invention is by way of example, and the scope of the invention is not limited to the exact details shown or described.

Having now described the features, discoveries and principles of the invention, the manner in which the improved high velocity cutting nozzle is constructed and used, the characteristics of the construction, and the advantageous, new and useful results obtained; the new and useful structures, devices, elements, arrangements, parts and combinations, are set forth in the appended claims.

1. A high velocity nozzle for connection to a fluid supply tube of a high pressure fluid cutting system, comprising:
a housing adapted for connection to the fluid supply tube, a bushing receiving bore extending from the fluid supply tube partially through said housing, and a spray outlet bore extending inwardly from a front surface of said housing which communicates with said bushing receiving bore through which the liquid is directed as a high velocity liquid jet;
a bushing that closely fits within said bushing receiving bore, having an end surface adapted to closely sealingly engage a mating surface of said housing within said bushing receiving bore, said bushing having a flow-directing bore for receiving the liquid from the fluid supply tube and extending at least partially through said bushing, said flow directing bore including a convergent inlet portion having an annular inner surface for reducing turbulence in said flow-directing bore, and an outlet portion formed with a convergent end surface and an annular inner surface between the convergent end surface and the convergent inlet portion.

2. The high velocity nozzle as defined in claim 1, comprising: an orifice plate in coaxial fluid communication with said flow-directing bore and said outlet bore, said orifice plate fitting within a sleeve receiving bore in one of said bushing and said housing immediately downstream of said flow-directing bore and abutting a shoulder of said bushing, said orifice plate having an orifice of a diameter that is smaller than a minimum diameter of said flow-directing bore for producing a high velocity fluid jet, with said orifice plate being positioned intermediate said bushing and said housing.

3. The nozzle defined in claim 2 in which the orifice plate is removably positioned i nto the sleeve receiving bore during use but is removable for replacement upon removal of said orifice housing and bushing from the fluid supply tube.

4. The nozzle defined in claim 3 in which the orifice plate further includes an orifice disk.

5. The nozzle defined in claim 4 further including a tubular support sleeve having an inner bore into which the orifice plate is affixed.

6. The nozzle defined in claim 2 in which the orifice plate includes a jewel formed with an orifice.

7. The nozzle defined in claim 6 in which the jeweled orifice is sapphire.

8. The nozzle defined in claim 1 in which the sleeve receiving bore extends inwardly from the end surface of the bushing and is in communication with the outlet portion of the flow directing bore at the shoulder.

9. The nozzle defined in claim 1 in which the bushing comprises a cylindrical body having a rearwardly tapering frustoconical surface opposite the end surface for contacting a mating frustoconical surface of the fluid supply tube so as to form a seal between said bushing and the fluid supply tube and retain said end surface of said bushing closely sealingly engaged with the mating surface of the housing within said bushing receiving bore.

10. The nozzle defined in claim 9 in which the frustoconical surface is disposed about a tapered head of the bushing, said tapered head being of a larger diameter than a remainder of the body, with an annular space remaining between said tapered head and the housing when said bushing is assembled to said housing.

11. The nozzle defined in claim 9 in which the housing includes an externally threaded portion configured to engage a mating internally threaded portion of the fluid supply tube, and an external wrench engaging portion for tightening said housing to the fluid supply tube.

12. The nozzle defined in claim 1 in which the annular inner surface of the outlet portion comprises a cylindrical surface with an annular curved convergent surface downstream thereof.

13. The nozzle defined in claim 1 in which the annular inner surface of the outlet portion comprises a cylindrical surface with an annular straight convergent surface downstream thereof.

14. The nozzle defined in claim 1 in which the annular inner surface of the outlet portion comprises a straight divergent surface with an annular curved convergent surface downstream thereof.

15. The nozzle defined in claim 1 in which the annular inner surface of the outlet portion comprises a straight divergent surface and an annular straight convergent surface downstream thereof.

16. The nozzle defined in claim 1 in which the annular inner surface of the convergent inlet portion is slightly inwardly convex.

17. The nozzle defined in claim 16 in which the annular inner surface of the outlet portion comprises a cylindrical surface with an annular curved convergent surface downstream thereof.

18. The nozzle defined in claim 16 in which the annular inner surface of the outlet portion comprises a cylindrical surface with an annular straight convergent surface downstream thereof.

19. The nozzle defined in claim 16 in which the annular inner surface of the outlet portion comprises a straight divergent surface with an annular curved convergent surface downstream thereof.

20. The nozzle defined in claim 16 in which the annular inner surface of the outlet portion comprises a straight divergent surface and an annular straight convergent surface downstream thereof.

21. The nozzle as defined in claim 1 in which the housing has an open end and in which
the housing has an open end and in which the bushing is seated in the housing through the open end and in which the fluid flows through the bushing and housing by entering the open end.

22. The nozzle as defined in claim 21 in which the bushing is adapted to be tightly seated by the fluid flow direction.

23. A high velocity cutting nozzle for connection to a fluid supply tube of a high pressure fluid cutting system, comprising:
a housing adapted for connection to the fluid supply tube, a bushing receiving bore extending from the fluid supply tube partially through said housing, and an outlet bore extending inwardly from a front surface of the housing which communicates with said bushing receiving bore;
a bushing that closely fits within said bushing receiving bore, having an end surface adapted to closely sealingly engage a mating surface of said housing within said bushing receiving bore, said bushing having a flow-directing bore for receiving the liquid from the fluid supply tube and extending at least partially through said bushing, said flow directing bore including a convergent inlet portion having an annular convergent inner surface, and an outlet portion having an annular inner surface and a convergent end surface, and a sleeve receiving bore that extends inwardly from said end surface of said bushing and joining with said outlet portion of said flow directing bore at a shoulder;
a tubular support sleeve having an inner bore which removably slip fits into said sleeve receiving bore of said bushing abutting said shoulder;
an orifice disk affixed within said inner bore of said tubular support sleeve, said orifice disk having an orifice of a diameter that is smaller than a minimum diameter of said flow-directing bore for producing a high velocity fluid jet, said orifice disk being positioned intermediate said bushing and said housing; and
wherein said orifice plate removably slip fits into said sleeve receiving bore during use but is removable for replacement upon removal of said housing and bushing from the fluid supply tube.

24. The nozzle defined in claim 23 in which the annular inner surface of the outlet portion comprises a cylindrical surface with an annular curved convergent surface downstream thereof.

25. The nozzle defined in claim 23 in which the annular inner surface of the outlet portion comprises a cylindrical surface with an annular straight convergent surface downstream thereof.

26. The nozzle defined in claim 23 in which the annular inner surface of the outlet portion com prises an annular straight divergent surface with an annular curved convergent surface downstream thereof.

27. The nozzle defined in claim 23 in which the annular inner surface of the outlet portion comprises an annular straight divergent surface and an annular divergent surface and an annular straight convergent
